(19) United States
(12) Patent Application Publication
(10) Pub. No.: US 2015/0304641 A1
(43) Pub. Date: Oct. 22, 2015

(54) DISPLAY DEVICE AND DISPLAY METHOD

(71) Applicant: SHARP KABUSHIKI KAISHA, Osaka-shi, Osaka (JP)

(72) Inventors: Ken INADA, Osaka-shi (JP); Asahi YAMATO, Osaka-shi (JP)

(73) Assignee: SHARP KABUSHIKI KAISHA, Osaka-shi, Osaka (JP)

(21) Appl. No.: 14/437,569

(22) PCT Filed: Oct. 25, 2013
(86) PCT No.: PCT/JP2013/078914

§ 371 Date: Apr. 22, 2015

(30) Foreign Application Priority Data
Nov. 2, 2012 (JP) 2012-242369

(51) Int. Cl. H04N 13/04

(52) U.S. Cl. CPC H04N 13/0409; H04N 13/0452

(57) ABSTRACT

In a display control circuit (200) of a display device (100) that enables 3-D display, a color correction table storage unit (22) stores a parameter (Mp) for adjusting a hue, and a data correction unit (23) corrects a pixel value by performing, based on the parameter (Mp), an arithmetic processing so as to change a blue hue. An adjustment is performed so as to match a hue in a case of 3-D display for which a parallax barrier is formed with a hue in a case of normal display for which the parallax barrier is not formed. Therefore, the adjustment is simple.

### TECHNICAL FIELD

The present invention relates to a display device and a display method. More specifically, the present invention relates to a display device and a display method employing a display panel that enables autostereoscopy.

### BACKGROUND ART

Recently, some display devices such as portable terminal devices employ a display panel that enables autostereoscopic display. Such a display panel includes a lenticular lens, or a parallax barrier formed of a shutter element, a film, or the like. When the lens, the film, or the like is provided, in a case of displaying a normal image which should not be displayed stereoscopically, the same image is provided to a left eye and a right eye of a user by different pixels. Therefore, a substantial display resolution in a horizontal direction (left-to-right direction) is reduced to a half, as compared with a display device having a structure in which the lens or the like is not provided.

In this respect, a parallax barrier formed of a shutter element (typically, a liquid crystal element) can be freely erased (i.e., can be brought into a non-formation state). Accordingly, the parallax barrier is not formed upon display of the normal image. Thus, the substantial display resolution in the horizontal direction (left-to-right direction) can be increased to be twice, as compared with the case where the lens or the film is provided.

However, a hue of the display panel in the state in which the parallax barrier is formed is frequently different from a hue of the display panel in the state in which the parallax barrier is not formed. Moreover, a liquid crystal panel for forming a parallax barrier is frequently different in configuration from a liquid crystal panel for displaying an image. Therefore, the difference in configuration frequently appears as a difference in hue. Further, display panels vary inherently in display quality (i.e., an individual difference). Therefore, the individual difference between two liquid crystal panels occasionally leads to a difference in hue. Hence, the hue needs to be adjusted for preventing a user from having an uncomfortable feeling.

Japanese Laid-Open Patent Publication No. 2006-91237 discloses a configuration of a display device that performs an image processing using a predetermined matrix, thereby adjusting a hue so as to correct variations in display quality owing to an individual difference of a lighting device.

### PRIOR ART DOCUMENT

### Patent Document

[Patent Document 1] Japanese Laid-Open Patent Publication No. 2006-91237

### SUMMARY OF THE INVENTION

### Problems to be Solved by the Invention

However, if the method of adjusting the hue in the conventional display device disclosed in Japanese Laid-Open Patent Publication No. 2006-91237 is applied as it is to a display device including two liquid crystal panels, times and efforts are expended, since adjustments to a display screen are required individually in a case of forming a parallax barrier and in a case of not forming the parallax barrier. Particularly, in a case where a user performs hue adjustments prior to the use of a device because of a secular change and the like, the user needs to perform complicated adjustments.

Hence, an object of the present invention is to provide a display device such as a portable terminal device including a display panel for forming a parallax barrier and a display panel for displaying an image, the display device capable of easily adjusting a hue in a case of forming the parallax barrier and in a case of not forming the parallax barrier.

### Means for Solving the Problems

According to a first aspect of the present invention, there is provided a display device that enables autostereoscopy by a parallax barrier scheme, the display device including: a first display panel configured to form a parallax barrier only in a case where the autostereoscopy is performed, based on an external control signal; a second display panel configured to form an image, based on an external video signal; and an image adjustment unit configured to adjust a correction amount of a pixel gradation value contained in the video signal, in one of a first case where the first display panel forms the parallax barrier and a second case where the first display panel does not form the parallax barrier, so as to match a hue upon external display of the image formed by the second display panel in the first case with a hue upon external display of the image formed by the second display panel in the second case.

According to a second aspect of the present invention, in the first aspect of the present invention, the display device further includes: a backlight device disposed on an opposite side to a display screen of the second display panel and configured to emit light passing through the second display panel, wherein the first display panel is a liquid crystal panel, and is disposed on a display screen side of the second display panel or between the display screen and the backlight device to form the parallax barrier that blocks or reduces the light passing through the second display panel.

According to a third aspect of the present invention, in the first aspect of the present invention, the image adjustment unit adjusts the hue by a matrix conversion.

According to a fourth aspect of the present invention, in the first aspect of the present invention, in the case of adjusting the hue, the image adjustment unit repeatedly performs an operation of allowing the first display panel to form the parallax barrier during a predetermined first period and then allowing the first display panel not to form the parallax barrier during a predetermined second period.

According to a fifth aspect of the present invention, there is provided a display method in a display device that enables autostereoscopy by a parallax barrier scheme and includes a first display panel configured to form a parallax barrier only in a case where the autostereoscopy is performed, based on an external control signal, and a second display panel configured to form an image, based on an external video signal, the display method including: a displaying step of externally displaying the image formed by the second display panel in a first case where the first display panel forms the parallax barrier and a second case where the first display panel does not form the parallax barrier; and an image adjusting step of adjusting a correction amount of a pixel gradation value contained in the video signal, in one of the first and second cases, so as to match a hue upon external display of the image in the displaying step in the first case with a hue upon external display of the image in the displaying step in the second case.

### EFFECTS OF THE INVENTION

According to the first aspect of the present invention, the image adjustment unit adjusts (the display gradation value of the image) so as to match the hue of one of the screen on which the parallax barrier is formed and the screen on which the parallax barrier is not formed with the hue of the other screen. Therefore, it is unnecessary to adjust the hues of the two screens independently of each other. Moreover, it is possible to easily match the hue in the case where the parallax barrier is formed with the hue in the case where the parallax barrier is not formed, in the liquid crystal panel that enables autostereoscopy.

According to the second aspect of the present invention, even in the case where a reduction in brightness is caused by the parallax barrier, it is possible to secure satisfactory display brightness by the backlight device and to easily adjust the hues in the case where the parallax barrier is formed and in the case where the parallax barrier is not formed.

According to the third aspect of the present invention, the hue is adjusted by a matrix conversion. Therefore, it is possible to perform the complicated conversion easily.

According to the fourth aspect of the present invention, the period in which the parallax barrier is formed and the period in which the parallax barrier is not formed are alternately repeated. Therefore, it is possible to adjust the hue so as to eliminate the remarkable difference in hue at the time of changeover.

According to the fifth aspect of the present invention, it is possible to have a similar effect to the effect according to the first aspect of the present invention, in the display method.

### BRIEF DESCRIPTION OF THE DRAWINGS

FIG. 1 is a block diagram illustrating a configuration of a liquid crystal display device according to one embodiment of the present invention.

FIG. 2 is a block diagram illustrating an overall configuration of a first display device according to the embodiment.

FIG. 3 is a schematic diagram illustrating a configuration of a display unit in the first display device according to the embodiment.

FIG. 4 is an equivalent circuit diagram of a pixel formation portion P(n,m) in the display unit according to the embodiment.

FIG. 5 is a diagram for illustrating the feasibility of autostereoscopy in the liquid crystal display device according to the embodiment.

FIG. 6 is a block diagram illustrating a configuration of a display control circuit according to the embodiment.

FIG. 7 is a diagram illustrating an example of a user interface allowing a user to input an instruction value in the embodiment.

### MODE FOR CARRYING OUT THE INVENTION

One embodiment of the present invention will be described below with reference to the attached drawings.

<1. Overall Structure of Liquid Crystal Display Device>

FIG. 1 is a block diagram illustrating an overall configuration of a liquid crystal display device according to the present embodiment. The display device 100 illustrated in FIG. 1 is typically a portable terminal device, and includes a first display device 10 which is a TFT liquid crystal panel for displaying an image, a second display device 20 which is a switch liquid crystal panel for forming a parallax barrier, and a terminal control device 30 which is a controller (hereinafter, the first display device is also referred to as a “TFT liquid crystal panel 10”, and the second display device is also referred to as a “switch liquid crystal panel 20”).

The terminal control device 30 is a general control computer, and includes a CPU, a RAM, a ROM, an input-output interface, and the like. The ROM stores therein an image adjustment program for making a hue adjustment which is a characteristic configuration of the present invention. In a case of providing a user interface for the adjustment to a user, the image adjustment program has a corresponding feature.

The terminal control device 30 outputs a control signal and a video signal to the first and second display devices 10 and 20. For example, in a case where the display device 100 is a portable terminal device for game, a video signal indicating a game screen which enables autostereoscopy is generated based on a game program stored in the ROM, the video signal is supplied to the first display device 10, and a control signal instructing to form a parallax barrier is supplied to the second display device 20. The contents of the video signal are not particularly limited. Preferably, both an image which can be autostereoscopically displayed and a normal image (which is not required to be displayed autostereoscopically) are provided during the use of the device. Also preferably, the video signal indicates such a color image that a difference in hue is recognized on a screen upon display of the respective images. However, even in a case where the video signal indicates a gray image, a difference in gradation corresponding to the difference in hue can be recognized. Therefore, an image indicated by the video signal is not limited to a color image.

The TFT liquid crystal panel 10 does not necessarily realize high-resolution and high-gradation display. However, high-quality display is frequently required in a case of, for example, a game screen. Therefore, a panel that realizes high-resolution and high-gradation display so as to be suitable for such display is frequently used. For this reason, generally, a hue adjustment to the TFT liquid crystal panel 10 that enables autostereoscopy can be set in detail. Further, the adjustment is frequently made to obtain an ideal hue in advance. However, a white hue occasionally changes because of an individual difference, a secular change, and the like of the liquid crystal panel. Moreover, the hue occasionally becomes slightly bluish.

Such a hue deviation is not clearly (immediately) recognized by the user at a glance in many cases. Even in a case where the user cannot recognize the difference in hue between the case of autostereoscopic display and the case of normal display only by viewing the liquid crystal panel in the autostereoscopic state, the user occasionally recognizes the hue deviation at the instant at which the parallax barrier is brought into the formation state or at the instant at which the parallax barrier is brought into the non-formation state, that is, upon switchover between the stereoscopic state and the non-stereoscopic state. Accordingly, the display device according to the present embodiment has a hue adjusting function (to be described later), in order to compensate such a hue deviation. Prior to describing this function, description will be given of configurations of the first and second display devices 10 and 20 corresponding to the two liquid crystal panels 10 and 20 which constitute the display device 100. Since these display devices are almost identical in basic configuration with each other, the configuration of the first display device 10 is described below. The switch liquid crystal panel 20 does not display an image, but displays a predetermined light shielding pattern for displaying a parallax barrier. The details are described later. In this specification, a hue of an image (or simply a hue) means a hue of an image to be displayed from the display device 100 toward the outside, and does not intend to basically mean a hue of an image formed on a display unit of the TFT liquid crystal panel 10, unless otherwise specified.

<2. Overall Configuration and Operations of Liquid Crystal Display Device>

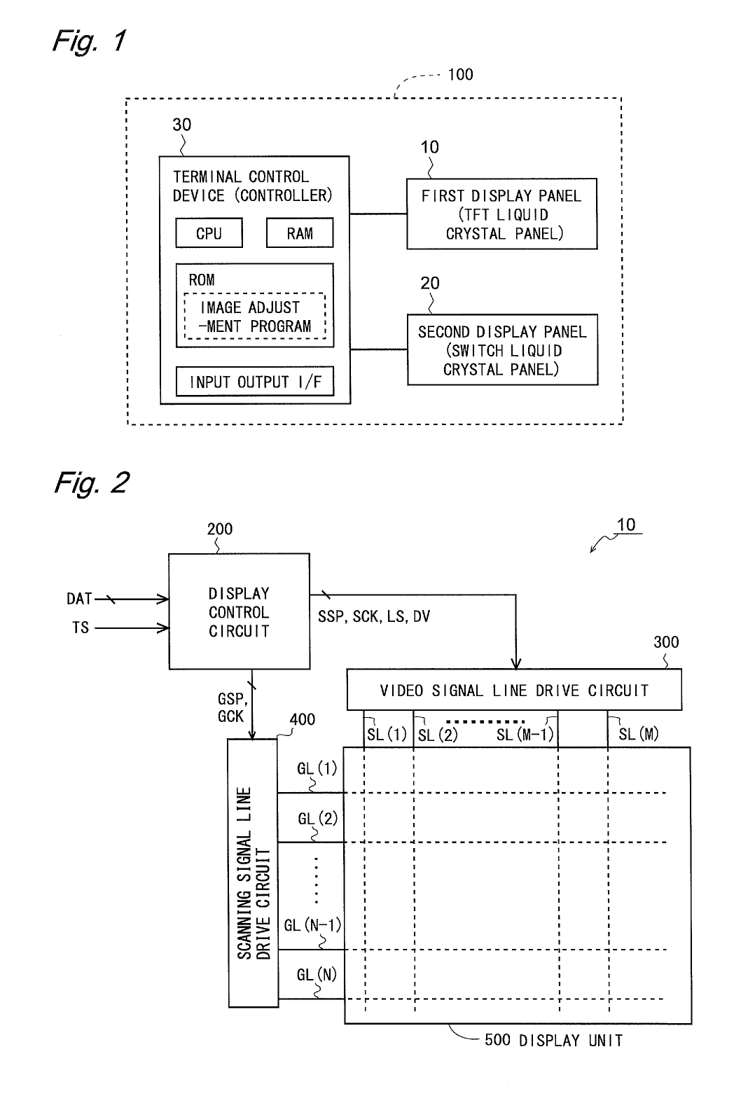

FIG. 2 is a block diagram illustrating an overall configuration of an active matrix-type liquid crystal display device which is the first display device according to one embodiment of the present invention. The first display device 10 includes a drive control unit including a display control circuit 200, a video signal line drive circuit 300, and a scanning signal line drive circuit (gate driver) 400, and a display unit 500.

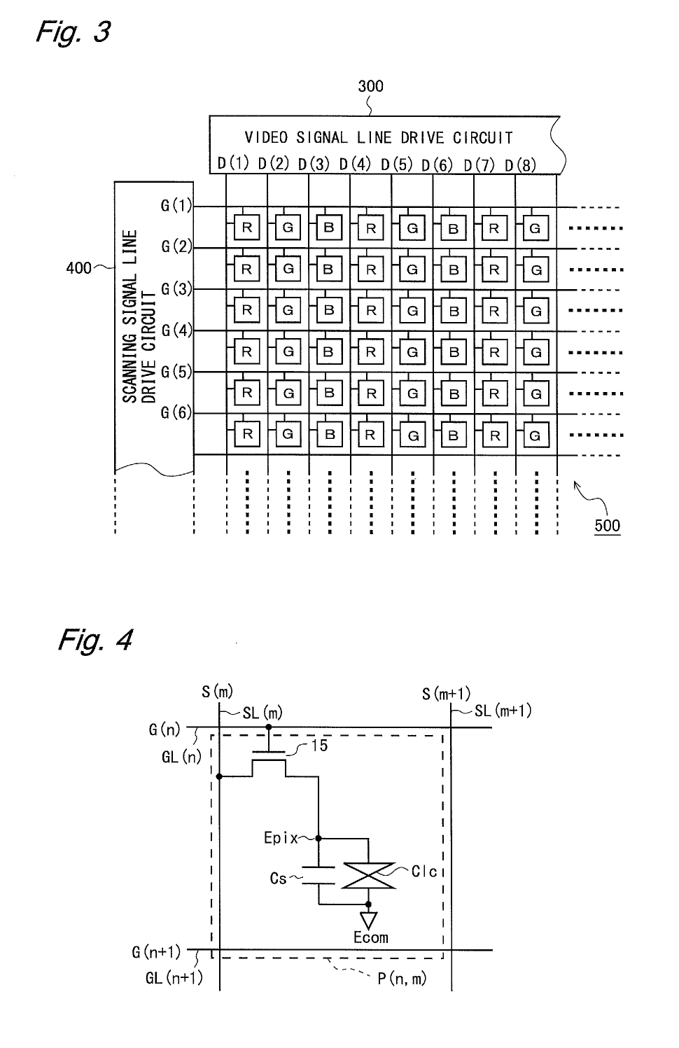

The display unit 500 illustrated in FIG. 2 includes a plurality (M) of video signal lines SL(1) to SL(M), a plurality (N) of scanning signal lines GL(1) to GL(N), and a plurality (M×N) of pixel formation portions formed on intersections between the video signal lines SL(1) to SL(M) and the scanning signal lines GL(1) to GL(N), respectively (hereinafter, the pixel formation portion on the intersection between the scanning signal line GL(n) and the video signal line SL(m) is denoted with reference character “P(n,m)”). The display unit 500 has a configuration illustrated in FIGS. 3 and 4. FIG. 4 schematically illustrates a configuration of the display unit 500 in the first display device. FIG. 4 illustrates an equivalent circuit of the pixel formation portion P(n,m) in the display unit 500.

As illustrated in FIGS. 3 and 4, each of the pixel formation portions P(n,m) includes: a TFT (Thin Film Transistor) 10 which is a switching element having a gate terminal connected to the scanning signal line GL(n) passing through the corresponding intersection, and a source terminal connected to the video signal line SL(m) passing through the intersection; a pixel electrode Epix connected to a drain terminal of the TFT 10; a common electrode (also referred to as a “counter electrode”) Ecom provided in common for the plurality of pixel formation portions P(i,j) (i: 1 to N, j: 1 to M); and a liquid crystal layer serving as an electrooptical element disposed in common for the plurality of pixel formation portions P(i,j) (i: 1 to N, j: 1 to M) and sandwiched between the pixel electrode Epix and the common electrode Ecom.

In FIG. 3, reference characters “R”, “G”, and “B” on the respective pixel formation portions P(n,m) denote “red”, “green”, and “blue” each of which is a color displayed by the relevant pixel formation portion P(n,m). In fact, accordingly, a set of pixels of R, G, and B formed by the pixel formation portions R, G, and B forms one color pixel.

It is assumed herein that the present embodiment employs a line reversal driving scheme which is a driving scheme of reversing an applied voltage to a common electrode by a common electrode drive circuit (not illustrated), and reversing the positive or negative polarity of an applied voltage to a pixel liquid crystal every row in the display unit 500 and every frame.

As illustrated in FIG. 4, in each of the pixel formation portions P(n,m), a liquid crystal capacitance Clc is formed by the pixel electrode Epix and the common electrode Ecom facing the pixel electrode Epix with the liquid crystal layer interposed between the common electrode Ecom and the pixel electrode Epix, and an auxiliary capacitance Cs is formed in the vicinity of the liquid crystal capacitance Clc.

When a scanning signal G(n) applied to the scanning signal line GL(n) becomes active, the scanning signal line is selected, so that the TFT 10 is brought into a conductive state. The pixel electrode Epix is applied with a drive video signal S(m) via the video signal line SL(m). Thus, a voltage of the applied drive video signal S(m) (a voltage provided with a potential at the common electrode Ecom as a reference) is written as a pixel value on the pixel formation portion P(n,m) including the relevant pixel electrode Epix.

The pixel formation portion P(n,m) realizes display by controlling the transmittance of light from (a light guide plate) of a backlight device (not illustrated). Therefore, the pixel formation portion P(n,m) including the backlight device is called a display element in this specification. As will be described later, however, the light from the backlight device is blocked selectively by the parallax barrier displayed on the switch liquid crystal panel 20 in the case where the autostereoscopy is performed.

The display control circuit 200 receives a display data signal DAT and a timing control signal TS from the outside. Then the display control circuit 200 outputs a digital image signal DV, and a source start pulse signal SSP, a source clock signal SCK, a latch strobe signal LS, a gate start pulse signal GSP, and a gate clock signal GCK for controlling timing to display an image on the display unit 500. Moreover, the display control circuit 200 corrects the received display data signal DAT appropriately so as to compensate a change in hue, and outputs the resultant digital data signal DAT as the digital image signal DV. The operations and specific configuration thereof will be described later.

The video signal line drive circuit 300 receives the digital image signal DV, the source start pulse signal SSP, the source clock signal SCK, and the latch strobe signal LS each outputted from the display control circuit 200. Then the video signal line drive circuit 300 applies a drive video signal to each of the video signal lines SL(1) to SL(M) in order to electrically charge the pixel capacitance of each pixel formation portion P(n,m) in the display unit 500. At this time, the video signal line drive circuit 300 successively holds the digital image signal DV indicating a voltage to be applied to each of the video signal lines SL(1) to SL(M), at timing when a pulse of the source clock signal SCK is generated. At timing when a pulse of the latch strobe signal LS is generated, the held digital image signal DV is converted into an analog voltage. The converted analog voltage is applied as the drive video signal all at once to all the video signal lines SL(1) to SL(M). That is, the present embodiment employs a line sequential driving scheme as a driving scheme for the video signal lines SL(1) to SL(M). The polarity of the video signal to be applied to each of the video signal lines SL(1) to SL(M) is reversed for alternating-current driving of the display unit 500.

The scanning signal line drive circuit 400 applies an active scanning signal to each of the scanning signal lines GL(1) to GL(N) successively, based on the gate start pulse signal GSP and the gate clock signal GCK each outputted from the display control circuit 200.

The common electrode drive circuit (not illustrated) generates a common voltage Vcom which is a voltage to be applied to a common electrode of a liquid crystal. The potential of the common electrode is changed by the alternating-current driving, in order to suppress the amplitude of the voltage at the video signal line.

Each of the video signal lines SL(1) to SL(M) is applied with the drive video signal, and each of the scanning signal lines GL(1) to GL(N) is applied with the scanning signal, as described above. Thus, the light transmittance of the liquid crystal layer is controlled, and an image is displayed on the display unit 500.

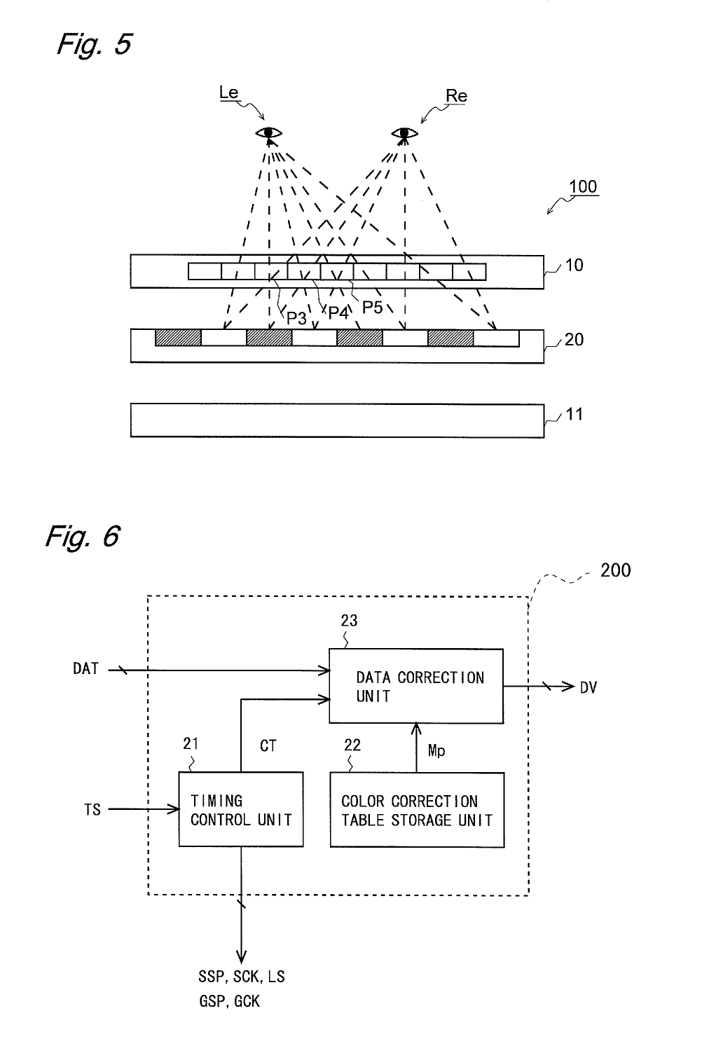

The TFT liquid crystal panel 10 is equal in operation to a normal liquid crystal display panel, but is different in contents of display from the normal liquid crystal display panel in the case where the autostereoscopy is performed. Moreover, the switch liquid crystal panel 20 forms the parallax barrier (performs the corresponding display). The autostereoscopy is described below with reference to FIG. 5.

FIG. 5 is a diagram for illustrating the feasibility of the autostereoscopy in the display device 100. As illustrated in FIG. 5, the display device 100 includes a backlight device 11 in addition to the first and second display devices 10 and 20. It is assumed herein that a display screen is disposed on an upper side of the figure. In this case, the TFT liquid crystal panel 10, the switch liquid crystal panel 20, and the backlight device 11 are stacked in this order from upper to lower sides of the figure. The cross section of FIG. 5 is obtained by cutting the display device in the stacked direction and in a horizontal direction (left-to-right direction) when being viewed from the user. In the present embodiment, the position of the TFT liquid crystal panel 10 and the position of the switch liquid crystal panel 20 may be exchanged. Alternatively, the TFT liquid crystal panel 10 and the switch liquid crystal panel 20 may be formed integrally as one panel. Moreover, the backlight device 11 may be omitted in a case of providing a liquid crystal panel, a reflective sheet, or the like for reflecting external light. In fact, however, the backlight device 11 is preferably provided because the parallax barrier lowers the display brightness.

That is, light emitted from the backlight device 11 passes through (the display unit of) the switch liquid crystal panel 20, passes through the display element of the TFT liquid crystal panel 10, and then reaches the right eye Re and left eye Le of the user. As described above, the display element displays any one of the colors of R, G, and B. The display element displays the pixel with a desired display gradation by changing the light transmittance of the corresponding liquid crystal.

The display element of the switch liquid crystal panel 20 is similar in structure to the display element of the TFT liquid crystal panel 10. However, the display element of the switch liquid crystal panel 20 is capable of switching the corresponding liquid crystal element between two kinds of display gradations responsive to two kinds of states, that is, a light shielding state in which light is not transmitted and a light transmitting state in which light is transmitted, specifically, a light shielding state in which the light transmittance is 0% or an approximate value to 0% and a light transmitting state in which the light transmittance is 100% or an approximate value to 100%.

In the switch liquid crystal panel 20, the display elements to be brought into the light shielding state are determined in advance, in order to form the parallax barrier in the case where the autostereoscopy is performed. The display elements which do not form the parallax barrier are brought into the light transmitting state. In the case where the autostereoscopy is performed, the switch liquid crystal panel 20 displays the light shielding pattern such that the parallax barrier is displayed.

The switch liquid crystal panel 20 illustrated in FIG. 5 is in a state where the light shielding pattern described above is displayed. In FIG. 5, the hatched display elements are in the light shielding state. In this light shielding pattern, the (planar) shape of the hatched portion is identical with the shape of a general parallax barrier formed of, for example, a film; therefore, the description thereof is omitted here.

Typically, the switch liquid crystal panel 20 is irradiated uniformly with the light from the backlight device 11 by an optical compensation sheet such as a light diffusion sheet. Accordingly, in a case where all the display elements of the switch liquid crystal panel 20 are in the light transmitting state, that is, in a case where the autostereoscopy is not performed, the TFT liquid crystal panel 10 is irradiated uniformly with the light from the backlight device 11 passing through the switch liquid crystal panel 20.

However, in the case where the autostereoscopy is performed, the display elements of the switch liquid crystal panel 20 block the light from the backlight device 11 selectively. The TFT liquid crystal panel 10 and the switch liquid crystal panel 20 are spaced apart from each other with a predetermined distance in the stacked direction (up-to-down direction in the figure). Therefore, the light from the backlight device 11 to the left and right eyes of the user is not necessarily blocked in a similar manner.

As illustrated in FIG. 5, for example, the display elements P3 and P5 of the TFT liquid crystal panel 10 are recognized, by the right eye Re of the user, to display desired gradations, since the light emitted from the backlight device 11 passes through the corresponding display elements of the switch liquid crystal panel 20. However, the display elements P3 and P5 are not recognized to display by the left eye Le of the user, since the light emitted from the backlight device 11 is blocked by the corresponding display elements of the switch liquid crystal panel 20.

As illustrated in FIG. 5, on the other hand, in a manner opposite to the manner described above, the display element P4 of the TFT liquid crystal panel 10 is recognized, by the left eye Le of the user, to display a desired gradation, since the light emitted from the backlight device 11 passes through the corresponding display element of the switch liquid crystal panel 20. However, the display element P4 is not recognized to display by the right eye Re of the user, since the light emitted from the backlight device 11 is blocked by the corresponding display element of the switch liquid crystal panel 20.

As described above, a well-known parallax barrier is formed by arranging at appropriate positions the display elements of the switch liquid crystal panel 20, the display elements being in the light-shielding state (i.e., by the predetermined light shielding pattern). Thus, the display elements of the TFT liquid crystal panel 10 are recognized only by one of the left and right eyes of the user. By using this feature, when the parallax barrier is formed, an image for left eye is displayed on the display element which can be recognized only by the left eye, and an image for right eye is displayed on the display element which can be recognized only by the right eye, among the display elements of the TFT liquid crystal panel 10. This enables the autostereoscopy. When enabling the autostereoscopy, the display data signal DAT contains an image obtained by combining the image for left eye with the image for right eye (herein, such that the image for left eye and the image for right eye are arranged alternately for each column).

It has been known that, as compared with a display device which does not include the switch liquid crystal panel 20, the display screen of the display device 100 has a slightly yellowish hue in the case of the normal display for which the autostereoscopy is not required, and has a slightly bluish hue in the case of performing the autostereoscopy. Accordingly, adjustments of the hue are frequently performed prior to factory shipment so as to prevent the hue from differing in the case of performing the autostereoscopy and in the case of not performing the autostereoscopy. However, it is considered that a user needs to adjust the hue ex-post facto because of various factors such as an unsatisfactory adjustment and a secular change. The present embodiment employs a configuration illustrated in FIG. 6 in order to perform such adjustments.

<3. Configuration and Operations of Display Control Circuit>

<3.1 Overall Configuration and Operations of Display Control Circuit>

FIG. 6 is a block diagram illustrating an overall configuration of the display control circuit according to the present embodiment. The display control circuit 200 includes a timing control unit 21 for performing timing control, a color correction table storage unit 22 for storing a parameter Mp (to be described later) for adjusting a hue, and a data correction unit 23 for receiving a pixel value (display gradation data) contained in a display data signal DAT applied from the outside of the device, and performing an arithmetic processing so as to change a blue hue in the present embodiment, thereby correcting the pixel value based on the parameter Mp stored in the color correction table storage unit 22.

First, the timing control unit 21 illustrated in FIG. 6 receives a timing control signal TS from the outside, and then outputs a control signal CT for controlling the operation of the data correction unit 23, and a source start pulse signal SSP, a source clock signal SCK, a latch strobe signal LS, a gate start pulse signal GSP, and a gate clock signal GCK for controlling timing to display an image on the display unit 500.

The color correction table storage unit 22 converts a pixel value (display gradation data) contained in a display data signal DAT supplied to the data correction unit 23, into corresponding brightness data. Specifically, the brightness data is obtained from the gradation data by referring to a lookup table (LUT) stored in the color correction table storage unit 22. Next, the obtained brightness data is subjected to a matrix conversion, and thereby is converted into target color data (brightness data). Specifically, the color conversion is performed by applying a predetermined three by three matrix of parameters (hereinafter, referred to as a “matrix parameter”) stored in the color correction table storage unit 22. Finally, a corresponding pixel value (display gradation data) is obtained from the brightness data obtained by the conversion, by referring to the LUT stored in the color correction table storage unit 22 again. By performing the matrix conversion using the matrix parameter, it is possible to perform the complicated conversion described above easily.

The device which is the color correction table storage unit 22 and stores the lookup table therein may be any types of storage devices. The color correction table storage unit 22 is preferably an EEPROM, a flash memory, or the like capable of erasing information electrically and capable of holding data stored therein even during power-down.

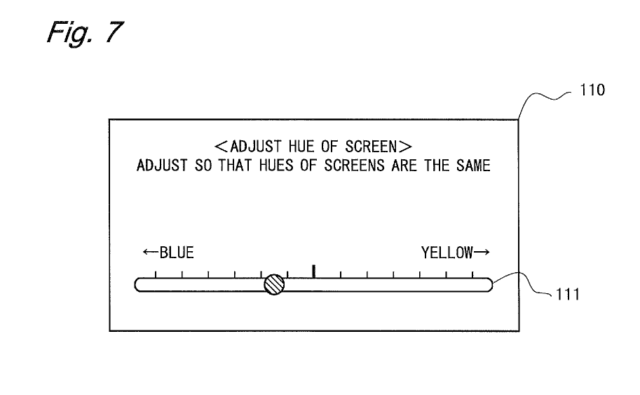

FIG. 7 is a diagram illustrating an example of a user interface allowing the user to input an instruction value. An adjustment bar display region 110 illustrated in FIG. 7 is a region to be displayed in the form of, for example, a pop-up window on a portion of the display screen of the TFT liquid crystal panel 10, and is displayed by a manipulation input to select a predetermined button (e.g., a screen adjustment button) on the TFT liquid crystal panel 10.

The adjustment bar display region 110 displays thereon a text to instruct the user to match a hue of a screen (normal screen) to be displayed in the state in which the autostereoscopy is not performed with a hue of a screen (3-D screen) to be displayed in the state in which the autostereoscopy is enabled (that is, the text instructs to prevent the hue from being changed). The adjustment bar display region 110 also displays thereon an adjustment bar 111 which is located under the text and functions as a slider bar. The adjustment bar 111 is provided with a round region (a hatched region in the figure) movable left and right. The user touches this region with, for example, his/her finger and moves this region left or right, thereby adjusting the hue of the screen of the TFT liquid crystal panel 10. This operation is realized by, for example, the image adjustment program stored in the ROM of the terminal control device 30.

For convenience of the description, only the hue of the normal screen is adjustable in the present embodiment. Alternatively, only the hue of the 3-D screen may be adjustable, or the hues of both the screens may be adjustable.

However, there is only small difference in hue between the two screens. Therefore, even when the adjusted hue deviates from an ideal hue, the user seldom recognizes the deviation. In contrast to this, if the hues of the two screens are different from each other, even when the hues are slightly different from each other, the user frequently recognizes the difference between the hues upon changeover between the 3-D screen and the normal screen. Accordingly, it is sufficient to perform an adjustment to match the hue of one of the 3-D screen and the normal screen with the hue of the other screen, in many cases. Therefore, it can be said that this method is suitable because the adjustment can be performed easily.

In FIG. 7, the hue of the screen of the TFT liquid crystal panel 10 can be set so as to change to yellow. However, the hue of the 3-D screen generally changes to a bluish color, as described above. Hence, the present embodiment may employ a configuration that a matrix parameter (correction value) predicted to be appropriate is calculated in advance, based on parameters including a secular change and the like, and this value is selected as a center value of the adjustment bar 111 and is set automatically. Thus, it is considered that the user who feels the hue is bluish adjusts the hue by moving the slider bar rightward.

It is assumed in the present embodiment that the 3-D screen and the normal screen are displayed alternately at the time when the adjustment bar display region 110 illustrated in FIG. 7 is displayed on the screen of the TFT liquid crystal panel 10. A length of a 3-D screen display period and a length of a normal screen display period are not particularly limited. In a case where the length is, for example, several seconds, it is considered that the 3-D screen display period is preferably shorter than the normal screen display period. This is because a user can understand that the hue of the screen displayed longer should be adjusted. However, if the length of display period is too long, the user needs long time to perform the adjustment and has a vague memory of the hue before the changeover, which is not preferable.

If the display period is set to be not more than one second, it is difficult to recognize whether the display screen is the 3-D screen or the normal screen. However, in the case of the changeover at short time intervals, it can be said that the difference in hue between the 3-D screen and normal screen is recognized more easily. This is because it is easy to feel the difference in hue between the two screens at the time of the changeover between the two screens. For this reason, the time interval for the changeover is preferably not more than one second. In the case where the time interval is not more than 1/60 seconds, the user cannot recognize the changeover itself. Therefore, the time interval is preferably set to be not less than 1/60 seconds.

In the present embodiment, the changeover between the 3-D screen and the normal screen is performed automatically. For example, the hue adjustment may be performed optionally in such a manner that a screen switch button is provided inside or in the vicinity of the adjustment bar display region 110 to allow a user to change the screen freely. Alternatively, the changeover itself may not be performed.

The data correction unit 23 receives a pixel value (display gradation data) contained in a display data signal DAT applied from the outside of the device, and performs a color conversion processing that employs the matrix parameter supplied from the color correction table storage unit 22, so as to change a blue hue.

For example, in a case where each of the pixel values of R, G, and B is 8-bit data with a 256-step gradation, the color correction table storage unit 22 stores therein plural sets of matrix parameter groups. Herein, one set includes the matrix parameters containing nine values each of which is, for example, 16-bit data. The number of sets corresponds to the number of correction levels (instruction values) designated by a user. The number of bits of the values of the matrix parameters is preferably larger than the number of bits of the gradation values since the conversion can be performed correctly, but may be smaller than the number of bits of the gradation values.

If all the devices are identical in correction amount (matrix parameter) with one another, only one matrix parameter Mp is required for one instruction value from a user. In a case where a hue is changed to be bluish, such a hue does not change occasionally with the same gradation in all the devices. Accordingly, the change amount is measured (or calculated) in advance, and the corresponding matrix parameter Mp is stored in the color correction table storage unit 22.

The storage element has a limited storage capacity and therefore stores therein the plurality of matrix parameters, and an intermediate value is interpolated by a well-known interpolating method such as linear interpolation. Specifically, the data correction unit 23 calculates such an intermediate value, based on the matrix parameter Mp supplied from the color correction table storage unit 22. Of course, one matrix parameter Mp may be stored without performing the interpolation calculation.

The plural sets of matrix parameters Mp are required because the accurate correction cannot be performed only by multiplying the values of the matrix parameter Mp by a fixed value in accordance with the instruction value from the user. When a hue is changed to be bluish, the hue never changes in the same manner in a case where the degree of change is large and in a case where the degree of change is small. The hue changes independently in a change amount according to a predetermined characteristic in the respective cases. Accordingly, this change characteristic is also measured (or calculated) in advance, and the matrix parameter Mp for each instruction value is stored in the color correction table storage unit 22.

In order to reduce the storage capacity, the stored matrix parameters Mp may be reduced to be smaller than preset instruction values from a user, for example, may be reduced to a half of the preset instruction values from the user, and the intermediate value may be obtained by a well-known interpolating method such as linear interpolation in a similar manner to that described above. Although there is a possibility that the hue cannot be corrected accurately, only one set of matrix parameters Mp may be stored, and the matrix parameters Mp may be multiplied in accordance with an instruction value from the user.

<4. Effect>

As described above, the display device 100 according to the embodiment, such as a portable terminal device having a screen that enables autostereoscopy, adjusts a hue of one of a 3-D screen and a normal screen so as to match the hue of one of the two screens with the hue of the other screen, in a case where the two screens are different in hue from each other. Therefore, it is unnecessary to adjust the hues of the two screens independently of each other. Thus, it is possible to match the hue of the 3-D screen with the hue of the normal screen easily in the liquid crystal panel that enables autostereoscopy.

<5. Modifications>

The foregoing embodiment employs the configuration to receive an instruction from a user as illustrated in FIG. 7, but may employ a configuration to automatically calculate a value corresponding to an instruction value. In a factory, a service center, or the like upon manufacture of products, typically, an imaging device such as a camera is connected to the portable terminal device. Images of a 3-D screen and normal screen each displayed on the TFT liquid crystal panel 10 are captured, and an instruction value is calculated such that hues of the two screens become equal to each other. The calculated instruction value is supplied to the color correction table storage unit 22. Thus, this configuration is similar to the configuration of the foregoing embodiment.

Moreover, a user does not instruct the color adjustment according to the foregoing embodiment, but only a person who knows a predetermined hidden command or password in a service center or the like may use the user interface illustrated in FIG. 7. Thus, it is possible to prevent erroneous color correction by a user in advance.

In the foregoing embodiment, the data correction unit 23 corrects a pixel value (of typically blue), based on the matrix parameter Mp stored in the color correction table storage unit 22. However, the color correction table storage unit 22 does not necessarily store therein the matrix parameter Mp in the form of a table. Moreover, the matrix parameter Mp may be obtained by calculation. Further, the data correction unit 23 may correct the pixel value, based on a parameter other than the matrix parameter Mp. In addition, a well-known gradation correcting method of, for example, correcting a gradation voltage may be employed in place of the foregoing configuration as long as a pixel gradation value is corrected eventually.

In the foregoing embodiment, the description is given on the assumption that the TFT liquid crystal panel 10 is a liquid crystal display device. However, the TFT liquid crystal panel 10 is not limited to a display device employing a liquid crystal as long as it is a matrix type display device. For example, the TFT liquid crystal panel may be a display device employing an electrooptical element such as an inorganic EL (Electro Luminescence) element or an organic EL element in place of a liquid crystal. Examples of the electrooptical element include all elements having optical characteristics which can be changed by applying electricity, such as an FED (Field Emission Display), a MEMS (Micro Electro Mechanical Systems) display, an LED, a charge drive element, and E ink, in addition to the EL element. Moreover, the switch liquid crystal panel 20 is not necessarily limited to a liquid crystal display device, and may be a device including a shutter element or a light shielding element capable of forming a parallax barrier.

### INDUSTRIAL APPLICABILITY

The present invention is applicable to an active matrix-type display device. More particularly, the present invention is suitable for a display device such as a portable terminal device employing a display panel that enables autostereoscopy.

### DESCRIPTION OF REFERENCE CHARACTERS

10: FIRST DISPLAY DEVICE (TFT LIQUID CRYSTAL PANEL)

20: SECOND DISPLAY DEVICE (SWITCH LIQUID CRYSTAL PANEL)

21: TIMING CONTROL UNIT

22: COLOR CORRECTION TABLE STORAGE UNIT

23: DATA CORRECTION UNIT

30: TERMINAL CONTROL DEVICE

100: DISPLAY DEVICE

200: DISPLAY CONTROL CIRCUIT

300: VIDEO SIGNAL LINE DRIVE CIRCUIT

400: SCANNING SIGNAL LINE DRIVE CIRCUIT

500: DISPLAY UNIT

G(k): SCANNING SIGNAL (k: 1, 2, 3, . . . )

GL(k): SCANNING SIGNAL LINE (k: 1, 2, 3, . . . )

D(j): VIDEO SIGNAL (j: 1, 2, 3, . . . )

SL(j): VIDEO SIGNAL LINE (j: 1, 2, 3, . . . )

Mp: MATRIX PARAMETER

CT, CS: CONTROL SIGNAL

1. A display device that enables autostereoscopy by a parallax barrier scheme, the display device comprising:
a first display panel configured to form a parallax barrier only in a case where the autostereoscopy is performed, based on an external control signal;
a second display panel configured to form an image, based on an external video signal; and
an image adjustment unit configured to adjust a correction amount of a pixel gradation value contained in the video signal, in one of a first case where the first display panel forms the parallax barrier and a second case where the first display panel does not form the parallax barrier, so as to match a hue upon external display of the image formed by the second display panel in the first case with a hue upon external display of the image formed by the second display panel in the second case.

2. The display device according to claim 1, further comprising:
a backlight device disposed on an opposite side to a display screen of the second display panel and configured to emit light passing through the second display panel, wherein
the first display panel is a liquid crystal panel, and is disposed on a display screen side of the second display panel or between the display screen and the backlight device to form the parallax barrier that blocks or reduces the light passing through the second display panel.

3. The display device according to claim 1, wherein
the image adjustment unit adjusts the hue by a matrix conversion.

4. The display device according to claim 1, wherein
in the case of adjusting the hue, the image adjustment unit repeatedly performs an operation of allowing the first display panel to form the parallax barrier during a predetermined first period and then allowing the first display panel not to form the parallax barrier during a predetermined second period.

5. A display method in a display device that enables autostereoscopy by a parallax barrier scheme and includes a first display panel configured to form a parallax barrier only in a case where the autostereoscopy is performed, based on an external control signal, and a second display panel configured to form an image, based on an external video signal, the display method comprising:
a displaying step of externally displaying the image formed by the second display panel in a first case where the first display panel forms the parallax barrier and a second case where the first display panel does not form the parallax barrier; and
an image adjusting step of adjusting a correction amount of a pixel gradation value contained in the video signal, in one of the first and second cases, so as to match a hue upon external display of the image in the displaying step in the first case with a hue upon external display of the image in the displaying step in the second case.
